(19) United States
(12) Patent Application Publication
(10) Pub. No.: US 2009/0030944 A1
(43) Pub. Date: Jan. 29, 2009

(54) CONTRACT-CENTRIC CONTENT SYSTEM

(76) Inventors: Bin Ni, Fremont, CA (US); Diego Lagunas, Los Gatos, CA (US); Mark P. Palaima, Saratoga, CA (US); Farhang Kassaei, San Jose, CA (US); Yitao Yao, Saratoga, CA (US)

Correspondence Address: SCHWEGMAN, LUNDBERG & WOESSNER/EBAY, P.O. BOX 2938, MINNEAPOLIS, MN, 55402, US

(21) Appl. No.: 11/961,887

(22) Filed: Dec. 20, 2007

Related U.S. Application Data
(60) Provisional application No. 60/961,618, filed on Jul. 23, 2007.

(51) Int. Cl. G06F 17/30

(52) U.S. Cl. 707/104.1; 707/E17.002

(57) ABSTRACT

A method and system to manage content is provided to generate an abstraction layer between a user application and content, based on a formal definition of content (referred to as a content contract). An example content system comprises a content bundle module, a user application, and a content access interface module. The content bundle module may be configured to store content items. A content item may include text items and placeholders. The user application, which does not have to be coded with specific knowledge regarding the content bundle, may be configured to receive a request to provide to a to a client system a presentation package (e.g., a web page) that has the content item, and to obtain the content item and any associated metadata from the content access interface module. Content item metadata may include, for example, information regarding a value to populate a placeholder in the content item.

### RELATED APPLICATIONS

This application is related to and hereby claims the priority benefit of U.S. Provisional Patent Application No. 60/961,618 filed Jul. 23, 2007 and entitled “CONTRACT-CENTRIC CONTENT SYSTEM”, which application is incorporated herein by reference in its entirety.

### TECHNICAL FIELD

This application relates to electronic commerce in general and a contract-centric content system in particular.

### BACKGROUND

A content system may be used by a software application that has presentation capability. For example, a web application may be designed to generate dynamic web pages using content templates that are stored in a repository, e.g., in a database. A content template typically includes a static portion (text) and one or more placeholders that can be replaced by the web application with appropriate data. When a web application receives a request for a web page from a browser application, the web application accesses the content template, replaces all placeholders with appropriate values, and provides the resulting web page to the browser. As the content templates do not include an indication of how the placeholder should be filled by the web application, a web application may need to include code to determine such information.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example embodiment may be implemented;

FIG. 2 is an example architecture illustrating processing a request for a web page, in accordance with one example embodiment;

FIG. 3 is a block diagram of a web page processor, in accordance with an example embodiment;

FIG. 4 is a flow chart of a method to process a request for a web page, in accordance with an example embodiment;

FIG. 5 is a block diagram illustrating the use of a contract-centric system, in accordance with an example embodiment;

FIG. 6 is a block diagram of a content access interface module, in accordance with an example embodiment;

FIG. 7 is a flow chart of a method to create and use a content contract, in accordance with an example embodiment; and

FIG. 8 is a diagrammatic representation of an example machine in the form of a computer system within which a set of instructions, for causing the machine to perform any one or more of the methodologies discussed herein, may be executed.

### DETAILED DESCRIPTION

A collection of content templates grouped for a specific purpose may be referred to as a “content bundle.” Content bundles may be utilized by various user applications such as, for example, a web application, an e-mail application, a desktop application, etc., that may request a presentation package (such as a web page) to be provided by a user application. Using an example of a web application, in order to display a greeting message that shows the name of a currently active user on a web page, a “Greeting” content template may be stored in a content bundle in an example format as follows: “Welcome <user_name>!” The string in the brackets is a placeholder and may designate a User Name variable to be filled in by the web application. A web application is coded to recognize a placeholder and provide an appropriate value for User Name to be displayed on the associated web page in the position of the placeholder <user_name>. When the web page is requested, the web application accesses the content template, replaces the placeholder <user_name> with an appropriate value (e.g., the value of the current user name), and provides the page to the requesting browser application. In this scenario, the greeting content template does not provide an indication of how the placeholder should be filled by the web application nor the semantics of the placeholder. The content author may be unaware of what kind of placeholders can be used in the content. Web application may also be unaware of what information is required to populate the associated content template. A modification of a content template (e.g., adding another placeholder to the content template to provide a “Greeting” content template with a placeholder for the date of the last log in (e.g., as “Welcome <user_name>! You last logged in on <date>.”) may cause the application to fail.

A so-called contract-centric system is described to provide a degree of separation and contract between a user application that receives and processes requests for content (e.g., web applications, desktop applications, etc) and the stored content. For example, where a user application is a web application, a contract-centric system provides a degree of separation between the web application that receives and processes requests for web pages and the content that is stored to accommodate the generation of the requested web pages. A contract-centric system may also be viewed as a content-driven solution for updating a user application. In one example embodiment, a contract-centric system may be utilized advantageously in the context of an enterprise-level presentation framework.

A method and system to manage content is provided to generate an abstraction layer between a web application and content, based on a formal definition of content referred to as a content contract. In one example embodiment, a source content bundle is examined, and a content specification language is utilized to create a content contract that is specific to the source content bundle. A content contract may include meta information associated with the content, such as content types, placeholder families, and content instance structure. Content types refer to reusable structures, such as, for example, Typed List, Typed Map, and Structure. Placeholder families refer to reusable groups of placeholders that can be used in the content. Content instance structure refers to the structure of an instance of the associated content bundle.

A content contract created for a content bundle (referred to as a source content bundle) may be used, in turn, to create an interface module that is termed a content access interface module. A content access interface module, in one example embodiment, serves the purpose of providing an API (application programming interface) between a web application and the source content. A content contract and the associated content access interface module is strong typed and provides the type safe access. A content access interface module, in one example embodiment, is implemented as a Java® application programming interface (API). Java® is a registered trademark of Sun Microsystems, Inc.

In one example embodiment, the source content bundle may be processed to generate a number of content bundles, e.g., content bundles with localized content or content bundles having different release versions. These resulting content bundles (of which there may be just one) are all based on the source content bundle and each of these content bundles may be referred to as a deployed content bundle.

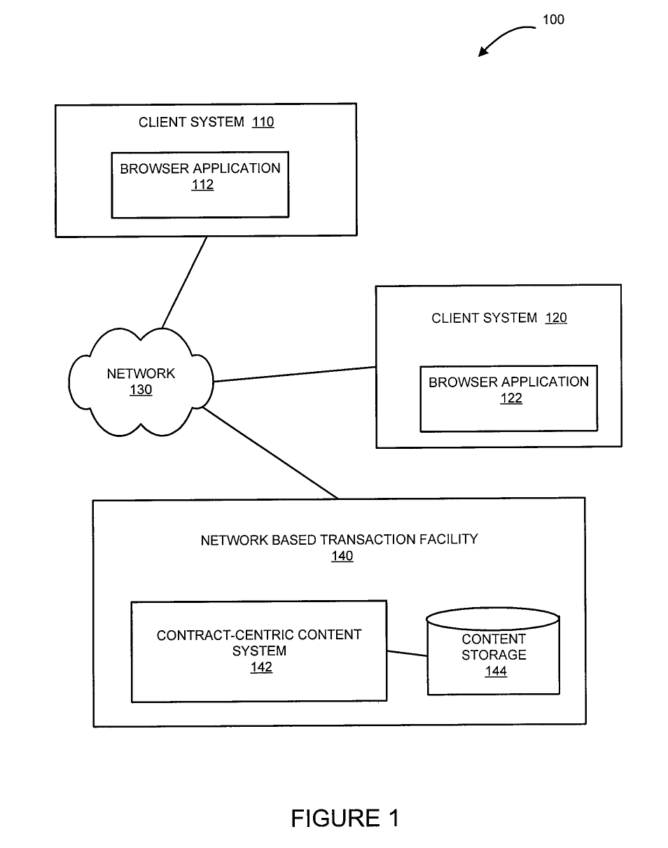

In operation, a web application may receive a request for a dynamic web page from a browser application on a client computer. The web application may determine that the requested web page requires certain content and pass control to an associated content access interface module. The content access interface module may determine an appropriate version of the content bundle, access the determined content bundle, retrieve the appropriated permutation of the content with the required data, and provide the web application with the content needed to generated the web page, as well as metadata associated with the content (e.g., the types of variables associated with placeholders present in the retrieved content). The web application may then generate and provide the requested dynamic web page to the requesting browser application. An example contract-centric system may be implemented in the context of a network environment 100 illustrated in FIG. 1. It will be noted that, while an example contract-centric content system is described herein as utilized by a web application a contract-centric content system may be utilized advantageously by other user applications that have presentation capability. Examples of such applications include e-mail applications, rich presentation applications, etc.

As shown in FIG. 1, the network environment 100 may include client systems 110 and 120 and a network-based transaction facility 140. The client systems 110 and 120 may run respective browser applications 112 and 122 and may have access to the network-based transaction facility 140 via a communications network 130. The communications network 130 may be a public network (e.g., the Internet, a wireless network, etc.) or a private network (e.g., a local area network (LAN), a wide area network (WAN), Intranet, etc.).

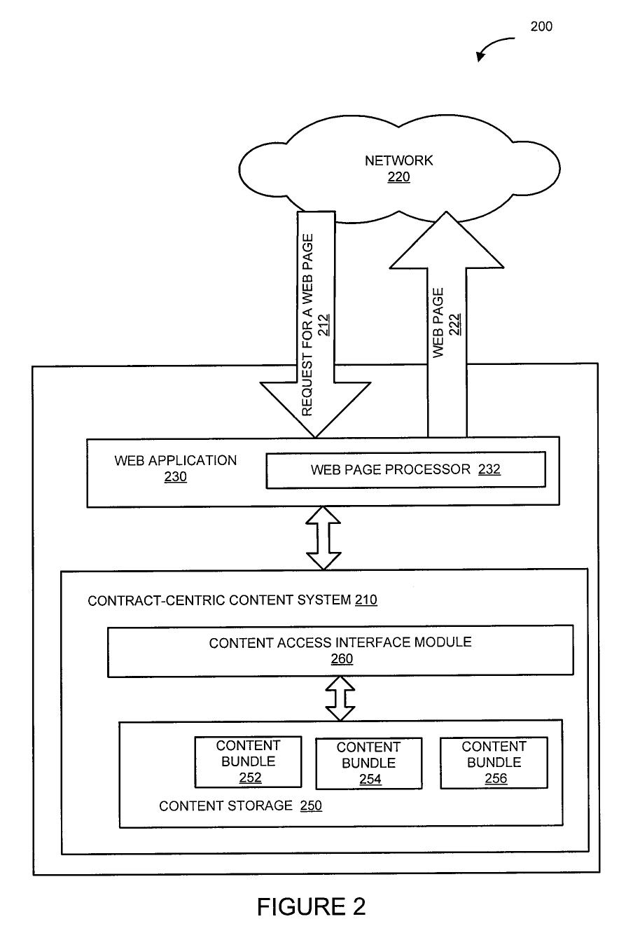

The client system 110 may utilize the browser application 112 to access services provided by the network-based transaction facility 140. The services provided by the network-based transaction facility 140 may employ a contract-centric content system 142, such that the knowledge regarding content stored in a content storage 144 is maintained separately from a web application that may utilize the content. In one embodiment, the network-based transaction facility 140 may be hosted by a web server. An architecture illustrating example use of the contract-centric system content 142 may be described with reference to FIG. 2.

An architecture 200 shown in FIG. 2 includes a web application 230 that is based on a contract-centric content system 210 receives requests 212 for web pages from a network 220 and, in return, provides the requested web pages 222 back to the network 220. As shown in FIG. 2, the example contract-centric content system 210 includes a content access interface module 240, and a content storage 250. Some of the modules of the web application 230 that may be configured to receive and process network requests (e.g., from browser applications) for web pages may be collectively referred to as a web page processor. An example web page processor 232 is illustrated as part of the web application 230. When a request for a dynamic web page is received by the web application 230 and the web application 230 determines that access to the content storage 250 is required in order to generate the requested web page, the web application 230 passes control to the content access interface module 240. The content access interface module 240 is derived from a content contract and may be configured to alleviate the need for code in the web application 230 that is specific to the content stored in the content storage 250.

As shown in FIG. 2, the content storage 250 may store multiple content bundles, such as content bundles 252, 254, and 256. These content bundles may be unrelated or they may reflect various content permutations based on the same source content bundle. For example, the content bundles 252 and 254 may have different release versions, while the content bundle 256 may be a localized version of the source content bundle. Various related content bundles may be termed permutations of the original content bundle. The content contract associated with the content access interface module 240 may be used as a compatibility key with respect to different permutations of the original content bundle. The content access interface module 240, in one example embodiment, determines, from the request for a web page, a version of a content bundle that is compatible with the web application 230, accesses the content bundle having that version, and provide the required content. The content access interface module 240 (e.g., the API of the content access) may be defined by the metadata in the associated content contract. Metadata, in one example embodiment, may include rules regarding filling the placeholders in the content templates that represent content with particular values. Metadata may also provide information regarding the type associated with content. Metadata, in one embodiment, may be defined utilizing content specification language mentioned above.

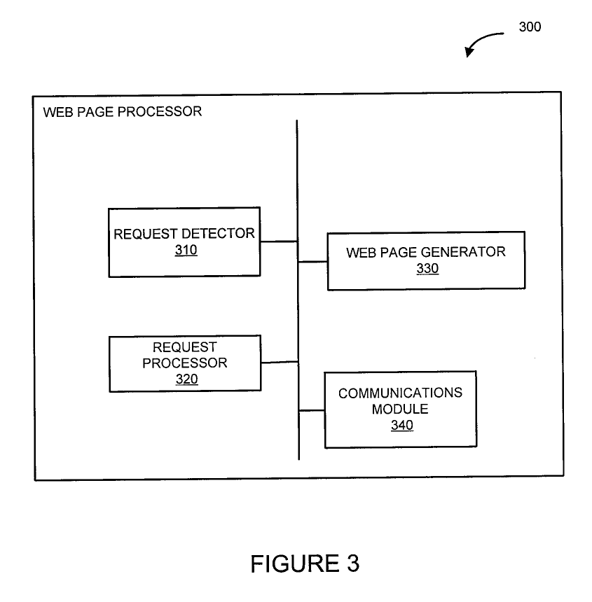

The web page processor 232 receives content and metadata and then generates the requested web page and provides it to the requesting browser application via the network 220. Thus, if changes are made to the content bundle 252, the updated content bundle 252 may be deployed without performing any code modifications in the web application 230. An example web page processor that may be part of the web application 230 is illustrated in FIG. 3.

FIG. 3 is a block diagram of a presentation module in an example form of a web page processor 300, in accordance with one example embodiment. As shown in FIG. 3, the web page processor 300 includes a request detector 310, a request processor 320, a presentation generator in an example form of a web page generator 330, and a communications module 340. The request detector 310 may be configured to receive requests, e.g., from browser applications, for web pages that include dynamic content. Dynamic content refers to content that may change depending on the context in which the web page is being rendered. For example, a greeting that is displayed on the web page that includes a user name that changes depending on which user has requested the web page is an example of dynamic content. As explained above, a content item may include a text item and a placeholder that is to be filled by the web application.

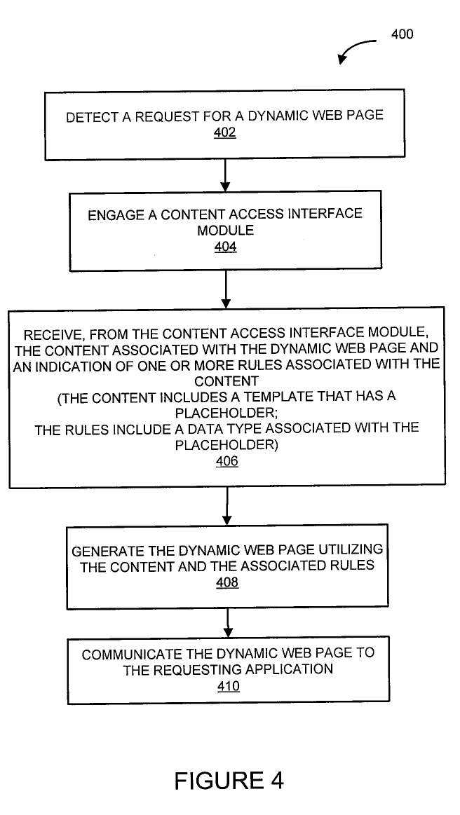

The request processor 320 may be configured to provide information associated with content items to the content access interface module 240. As discussed above, a content access interface module is created to be separate from a web page processor such that it provides an abstraction layer between a web application and the content that may be used by the web application. The web page generator 330 may be responsible for receiving the content and associated metadata from a content access interface module and for generating the requested web page. The communications module 340 may be configured to provide the requested web page to the requesting browser application. An example method to process a request for a dynamic web page can be described with reference to FIG. 4.

FIG. 4 is a flow chart of a method 400 to process a request for a dynamic web page, according to one example embodiment. The method 400 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the transaction processing system 140 of FIG. 1 and, specifically, at the contract-centric content system 142. In another example embodiment, the processing logic may be distributed between various servers at the network based transaction facility 140 of FIG. 1.

As shown in FIG. 4, the request detector 310 of FIG. 3 detects a request for a dynamic web page at operation 402, e.g., from a browser application running on a client system. The request processor 320 of FIG. 3 determines, from the request, that the dynamic web page requires content from the content storage 250 of FIG. 2 and engages the content access interface module 240, also of FIG. 2, at operation 404. At operation 406, the request processor 320 receives, from the content access interface module 240, the content (e.g., in the form of one or more content templates) and metadata associated with the requested dynamic web page, including an indication of any rules associated with the received content. For example, the rules may be related to one or more placeholders present in the received content. In one example embodiment, the rules are provided as an API. The web page processor 300 thus does not need to guess how to fill the placeholders that are present in the content templates retrieved from the content storage 250. The web page generator 330 of FIG. 3 generates the dynamic web page utilizing the received content and metadata, at operation 408. The communications module 340 provides the generated web page to the requesting browser application, at operation 410.

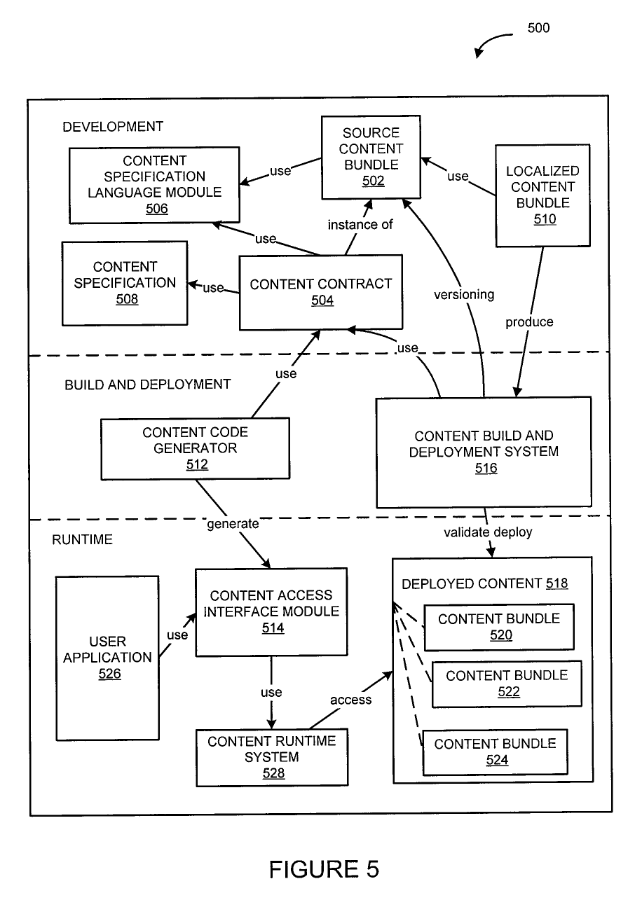

As mentioned above, the content access interface module 240 utilized in the method 400 is generated based on a content contract that provides a formal definition of content stored in a source content bundle. Various modules of the contract-centric content system 142 may be employed throughout different phases of a life-cycle of a web application. Different nodules may be engaged during development, build and deployment and runtime phases. Example utilization of the contract-centric content system 142 and its components may be described with reference to FIG. 5.

FIG. 5 is a block diagram illustrating the use of a contract-centric system 500, in accordance with an example embodiment. As shown in FIG. 5, during a development phase, a content contract 504 is created, utilizing a content specification language module 506 and a content specification 508. The source content bundle is created by following the contract. The source content bundle 502 may be processed to generate a localized content bundle 510, e.g., for use in another country or region.

During a build and deployment phase, the contract-centric system 500 engages a content code generator 512. The content code generator 512 may be used to generate a content access interface module 514 for use during runtime. Also during a build and deployment phase, a content build and deployment system 516 generates deployed content 518. The deployed content 518 may include different versions of the content (e.g., content bundles 520, 522, and 524) that may be based on the source content bundle 502 or on the localized content bundle 510.

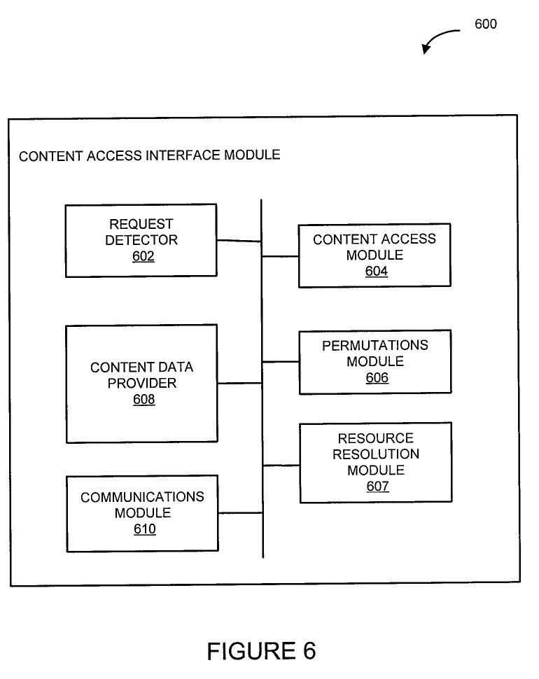

During runtime, the deployed content 518 may be accessed by a user application 526, which may be a web application or any other application configured to utilize content, through the use of the content access interface module 514. In one example embodiment, the content access interface module 514 is supported by a content runtime system 528. An example content access interface module may be described with reference to FIG. 6.

As shown in FIG. 6, an example content access interface module 600 may include a content access module 604, a permutation detector 606, a resource resolution module 607, a content data provider 608, and a rendering module 610. The request detector 602 may be configured to receive, from the web page processor 300, a request to provide a content item. The request from the web page processor 300 may be associated with a request from a client's browser application to generate a dynamic web page. The requested content item may be in a form of a content template and include a text item and a placeholder.

The content access module 604 may be configured to access the content bundle that stores the requested content. As mentioned above, the content access interface module 600 may include the permutation detector 606 to determine an appropriate permutation of the content bundle (e.g., a content bundle having a version that is compatible with the requesting web application or an appropriate localized version of the content bundle) and the resource resolution module 607 to locate a content bundle that corresponds to the determined permutation. The content access module 604 may also be responsible for obtaining the requested content item from the content bundle. The content data provider 608 may be configured to determine information associated with the obtained content item.

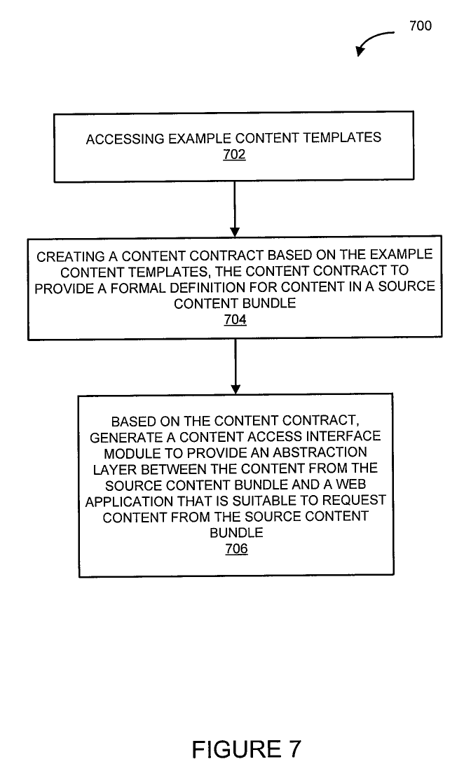

It will be noted that the modules described above are example modules and that a content access interface module may be implemented in a variety of fashions in order to provide functionality described herein. As explained above, a content access interface module may be created based on a particular content contract. An example method to create a content contract and an associated content access interface module can be described with reference to FIG. 7.

FIG. 7 is a flow chart of a method 700 to create a content contract and generate an associated content access interface module, according to one example embodiment. The method 700 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the transaction processing system 140 of FIG. 1 and, specifically, at the contract-centric content system 142. In another example embodiment, the processing logic may be distributed between various servers at the network based transaction facility 140 of FIG. 1.

Referring back to FIG. 5, the operations illustrated in the flow chart of FIG. 7 are performed during the development phase and the build and deployment phase. As shown in FIG. 7, example content templates are accessed at operation 702. A content contract (e.g., the content contract 504 illustrated in FIG. 5) is created at operation 704, utilizing the content specification language module 506 and the associated content specification 508 (also illustrated in FIG. 5). The content contract 504 may also be created based on the source content bundle 502 to provide a formal definition for content in the source content bundle 502. At operation 706, the content code generator 512 of FIG. 5 generates a content access interface module (e.g., the content access interface module 514), based on the content contract 504. The content access interface module 514 may be generated such that it is suitable for serving as an intermediary between a web application (e.g., the user application 526) and the deployed content 518.

As mentioned above, in some embodiments, a content contract may be created based on example templates. The content contract may be then used by an author of the associated content bundle to guide the author in correctly creating (or modifying) the content bundle.

It will be noted that a contract-centric content system may be implemented in a variety of ways, utilizing a variety of equipment components and programmatic techniques. Some example implementation details are described below.

An Example Schema for Content Contracts

In the root node, according to an example embodiment, the new content infrastructure version number id is collapsed from three attributes to a single one.

```
<ContentContract
  version=“2.0”
  id=“DarwinCoreComponentsTests.BasicConcepts”
  xmlns=“http://www.ebay.com/2006/v4/content”
  xmlns:its=“http://www.w3.org/2005/11/its”
  xmlns:xsi=“http://www.w3.org/2001/XMLSchema-instance”
  xsi:schemaLocation=“http://www.ebay.com/2006/v4/content
../../../schema/V4Content2.xsd”>
```

A content specification, according to one example embodiment, defines placeholder types, their semantics, and a list of target id's for permutation overrides. There may be one specification maintained for an on-line marketplace. Each placeholder type may belong to a family and can contain zero or more children of a specified family. Each placeholder type may be used statically in a content element, provided that it is an allowed placeholder type. A content specification may specify what to use as the default markup family if a content element itself does not provide this information.

```
<ContentSpecRef
  id=“EbayContentSpec”
  defaultFamily=“Text”/>
```

A dynamic tamely, e.g., a ContentModel element, may be implemented to define a set of dynamic placeholders that could be used in a content element. Placeholder types may be defined in the content specification. In a content contract, multiple ids can be defined in a single line. A content contract may also define multiple dynamic families. Dynamic families may extend other dynamic families that may be referred to utilizing a format as follows.

[fully_qualified_contract_id]#<dynamic_family_name>

For example, a reference within the same content contract may be as follows: “#MyDynamicFam1.” A reference to other contracts may be as follows: “HisPrj.His4cc#HisDynamicFam.”

If placeholders in a dynamic family are of a type that is not allowed in the default family, a static family that includes them may be declared. Because, in one example embodiment, one content specification for one content contract is provided, static family references may be simply the family names without further qualification, as shown below.

```
<DynamicFamily
  name=“MyContract”
  extends=“#MyBasecontract”
  staticFamily=“Text”>
    <PH type=“Integer” ids=“maxDays minDays blogEntry”/>
    <PH type=“Money” ids=“price”/>
</DynamicFamily>
```

Content types may be provided. For example, Content elements that are different from default family may be declared. Content maps may declare keys to be able to switch the content based on the declared keys. A content list, in one example embodiment, is a variable-length collection of items that do not require keys. In one embodiment, maps and lists may be of simple ContentElement only but also may be maps and lists of any other content type.

```
<ContentTypes>
  <ContentElement id=“RichElement” staticFamily=“InlineHtml”/>
  <ContentMap id=“EstimatedArrivalTimeType” keys=“ONE TWO
RANGE”/>
  <ContentMap id=“SearchSortByType” keys=“1 2 3 4 5 6 7”/>
  <ContentList id=“MenuBarType”/>
  <ContentList id=“Menu1ListType” contentType=“RichElement”/>
</ContentTypes>
```

Content Instance, in one example embodiment, specifies a content contract generated for a particular content bundle based on the types defined in the same or other contracts. An instance is a series of content unit items, which are named instances (e.g., they have an id) of a specific content type, and that can optionally allow dynamic placeholders. If a content unit defines a dynamic family, that dynamic family may only be of the same static family or a subset allowed by the content type. Ids can be scoped within a pre-defined group. A content instance, in one example embodiment, defines the access method to the content unit in the content bundle (e.g., it defines ids and also whether a data model needs to be passed in or not). Example implementation of a content instance is provided below.

```
<ContentInstance>
  <ContentUnit id=“Greeting”/>
  <ContentUnit id=“Label”/>
  <ContentUnit id=“FinalPrice” dynamicFamily=“#MyContract”/>
  <ContentUnit id=“EstimatedArrivalTime”
contentType=“EstimatedArrivalTimeType”
dynamicFamily=“#MyContract”/>
  <ContentUnit id=“SearchSortBy”
contentType=“#SearchSortByType”/>
  <ContentUnit id=“Results” dynamicFamily=“#MyContract”/>
  <ContentUnit id=“BrandNew”/>
  <ContentUnit id=“MenuBar” contentType=“#MenuBarType”
dynamicFamily=“#MyContract”/>
  <Group id=“Menu1”>
    <ContentUnit id=“Menu1List” contentType=“#Menu1ListType”/>
  </Group>
</ContentInstance>
```

### An Example Content Specification

A content schema may be configured to suppress or to not aid auto-completion of placeholders and their attributes. Below is an example list of families, placeholders, and their attributes supported by the example content specification.

```
Static Families:
  Text
  LinkContent
  InlineContent
Value placeholder types: (these placeholders cannot contain any children)
  String
  Integer
  Long
  Double
  JsToken
    seq
  Date
    dateFormat - “NONE”, “SHORT”, “MEDIUM”, “NUMERIC”,
      “NUMERIC_NO_DAY”, “LONG”, “FULL”,
      “FULL_NO_YEAR”
    timeFormat - “NONE”, “SHORT”, “MEDIUM”,
      “SHORT_ZONE”, “LONG_AMPM”, “LONG”
  Money
    currencyInfoFormat - “NONE”, “SIMPLE”, “FULL”
    currencySymbolFormat - “SIMPLE”, “STANDARD”,
      “FANCY”, “ALL”
  Image
    imageId
    imageIdType - “PICS”, “URL”
    l-alt
    l-title
    width
    height
Markup placeholder types: (these placeholders may contain children
text/elements)
  Link
    linkId
    linkIdType - “STATIC”, “EXTERNAL”, “URL_COUNTRY”,
      “URL_EBAY”, “URL”, “CUSTOM”
    l-title
    isSecure
  Style
    styleId - “U”, “TT”, “I”, “B”, “BIG”, “SMALL”, “EM”,
      “STRONG”, “CITE”, “DFN”, “CODE”, “SAMPL”, “KBD”,
      “VAR”, “ABBR”, “ACRONYM”, “SUB”, “SUP”
    l-title
```

### Internationalization Tag Set

In one example embodiment, an Internationalization Tag Set (ITS) is used to describe localization aspects of the Extensible Markup Language (XML) file. Listed below are example attributes that may be used to describe a content element.

```
its:translate=“no” - used to indicate not to translate certain elements, such
  as test bundles; or special cases, such as “Francais” control button in a
  Canada English page
its:locNote=“<string>” - used to provide hints to translators (e.g., where in
  the page the string is used or how it should be translated)
```

It will be noted that while example implementation details are described above, various other techniques may be utilized in further embodiments. In one example embodiment, a machine-readable medium is provided having instruction data to cause a machine to receive, at a web page processor, a request to provide a web page with a content item, the content item including a text item and a placeholder; provide information associated with the content item to the content access interface module, the content access interface module being separate from the web page processor; receive, from the content access interface module, information regarding a value required to populate the placeholder; and generate the requested web page, utilizing the information regarding a value required to populate the placeholder. Machine readable medium will be understood as a medium that is capable of storing data in a form that can be accessed by an automated sensing device. Examples of machine-readable media include magnetic disks, cards, tapes, and optical disks, as well as other forms of volatile and non-volatile memory devices.

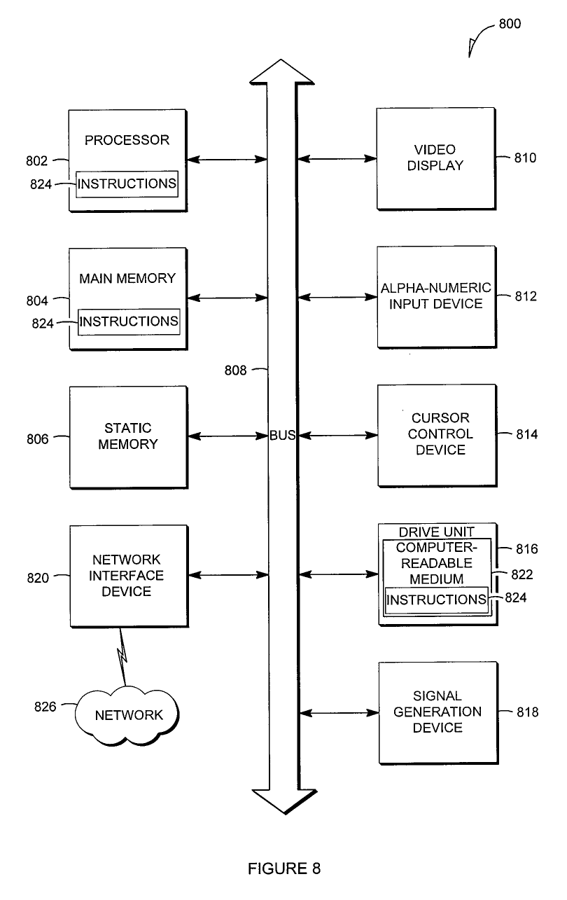

FIG. 8 shows a diagrammatic representation of a machine in the example form of a computer system 800 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU) or both), a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an alpha-numeric input device 812 (e.g., a keyboard), a user interface (UI) navigation device 814 (e.g., a cursor control device), a disk drive unit 816, a signal generation device 818 (e.g., a speaker) and a network interface device 820.

The disk drive unit 816 includes a machine-readable medium 822 on which is stored one or more sets of instructions and data structures (e.g., software 824) embodying or utilized by any one or more of the methodologies or functions described herein. The software 824 may also reside, completely or at least partially, within the main memory 804 and/or within the processor 802 during execution thereof by the computer system 800, with the main memory 804 and the processor 802 also constituting machine-readable media.

The software 824 may further be transmitted or received over a network 826 via the network interface device 820 utilizing any one of a number of well-known transfer protocols (e.g., Hyper Text Transfer Protocol (HTTP)).

While the machine-readable medium 822 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of embodiments of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware.

Thus, a contract-centric content system has been described. A contract-centric content system may contribute, as discussed above, to the separation of concerns with respect to the three aspects of content design: content consumer (e.g., Java), content contract, and actual localized content. A content contract, in one embodiment, provides a formal definition of a content bundle. A formal definition may include id's for every string that needs to be provided, as well as a list of placeholders that the content can leverage and the Java application may need to provide. The content contract is particularly important because it is may be used to generate Java classes to represent content strings. All content references in the Java code are made through these code-generated classes so that all references to non-existent content (e.g., because of a typo or because that content has been removed) end up in a compile-time error rather than a runtime exception (as it would happen with resource bundles, for example). From a separation of concerns point of view, the a content contract occupies space between a developer's world (Java) and the content manager/translation world that describes rules of interaction.

Although embodiments have been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense.

1. A content system comprising:
a content bundle to store content including a content item, the content item including a text item and a placeholder;
a user application to receive a request to provide a presentation package including the content item, the user application lacking specific code to describe the content bundle; and
a content access interface module to provide, to the user application, information regarding a value to populate the placeholder, the content access interface module to provide a layer of separation between the user application and the content bundle.

2. The system of claim 1, wherein the content bundle is from a plurality of content bundles, each content bundle from the plurality of content bundles associated with a particular release version.

3. The system of claim 2, wherein the content access interface module is to determine the content bundle from the plurality of content bundles based on a release version of the content bundle being compatible with the user application.

4. The system of claim 2, wherein the content bundle from the plurality of content bundles is a localized version of a source content bundle.

5. The system of claim 1, wherein the content access interface module is generated based on a content contract associated with a source content bundle, the content contract to provide a formal definition of content from the content bundle.

6. The system of claim 5, wherein the content contract is generated utilizing a content specification language, the content contract to define metadata associated with content from the source content bundle.

7. The system of claim 1, wherein the user application is a web application and the presentation package is a web page.

8. A method comprising:
receiving, at a content access interface module, a request to provide a content item, the content item including a text item and a placeholder;
accessing a content bundle;
obtaining the requested content item from the content bundle;
determining meta information associated with the content item; and
providing the content item and the meta information associated with the content item to a user application.

9. The method of claim 8, wherein the accessing of the content bundle comprises determining the content bundle from a plurality of content bundles based on a release version of the content bundle being compatible with the user application.

10. The method of claim 8, wherein the meta information associated with the content item is to describe a value required to populate the placeholder.

11. A method comprising:
accessing a source content bundle;
creating a content contract based on the source content bundle, the content contract to provide a formal definition for content associated with the source content bundle; and
based on the content contract, generating a content access interface module to provide an abstraction layer between a user application and stored content and to make content associated with the source content bundle suitable for use by the user application.

12. The method of claim 11, wherein the content access interface module is to determine a content bundle from a plurality of content bundles based on a release version of the content bundle being compatible with the user application.

13. The method of claim 11, wherein the content contract is to describe values required to populate their respective placeholders in associated content templates from the source content bundle.

14. The method of claim 11, wherein the generating of the content contract comprises utilizing a content specification language.

15. The method of claim 14, wherein the content specification language is associated with content specification, the content specification being a customizable part of the content specification language.

16. The method of claim 11, wherein the content contract includes strong typed metadata associated with the content.

17. The method of claim 11, comprising storing the content bundle remotely from the content access interface module.

18. The method of claim 11, comprising:
receiving, at the user application, a request to provide a web page with a content item, the content item including a text item and a placeholder;
providing information associated with the content item to the content access interface module, the content access interface module being separate from the user application;
receiving, from the content access interface module, information regarding a value required to populate the placeholder; and
generating the requested web page, utilizing the information regarding the value required to populate the placeholder.

19. The method of claim 18, including providing the generated web page to a browser application, from which the request was initiated.

20. The method of claim 18, wherein the accessing of the content bundle comprises determining the content bundle from a plurality of content bundles based on a version of a content bundle being compatible with the user application.
